(19) United States
(12) Patent Application Publication
(10) Pub. No.: US 2008/0271953 A1
(43) Pub. Date: Nov. 6, 2008

(54) Incline Lift Unit and Incline Lift

(75) Inventor: Dennis Vroegindeweij, Ursem (NL)

Correspondence Address: HOFFMANN & BARON, LLP, 6900 JERICHO TURNPIKE, SYOSSET, NY, 11791, US

(73) Assignee: FREELIFT B.V., Heerhugowaard (NL)

(21) Appl. No.: 12/088,278

(22) PCT Filed: Oct. 5, 2006
(86) PCT No.: PCT/NL2006/000502

§ 371 Date: Mar. 27, 2008

(30) Foreign Application Priority Data
Oct. 6, 2005 (NL) 1030131

(51) Int. Cl. B66B 9/08

(52) U.S. Cl. 187/245

(57) ABSTRACT

An incline lift unit (2) is designed for conveying a load along a guide (3) with a varying angle of inclination. The incline lift unit (2) comprises a conveying unit (5), which is designed to be carried by the guide (3) and to move along the guide (3). The incline lift unit (2) comprises a load carrier (4), which is rotatably connected to the conveying unit (5). The incline lift unit (2) comprises rotation means (31) and a control unit (37) for driving the rotation means (31) in such a manner that the load carrier (4) assumes a desired orientation relative to the vertical. The conveying unit (5) comprises a conveying frame (29) and two-gear mechanisms (41). The gear mechanisms (41) are rotatably connected to the conveying frame (29) and comprise a gearwheel (49). The gearwheel (49) is intended for engagement with a gear rack (22) of the guide. The incline lift unit (2) furthermore comprises detection means (55) for detecting a difference in rotation of the gearwheels (49). The control unit (37) is designed to drive the rotation means (31) based on the observation of the detection means (55).

The invention relates to an incline lift unit according to the preamble of claim 1. Incline lift units of this type are able to move along a guide with a varying angle of inclination, and are designed for conveying a load. Such a load may be an individual who has trouble walking and sits down on a chair on the incline lift unit or sits on a platform of the incline lift unit in a wheelchair. Incline lift units of this type are generally used on a staircase and are therefore also referred to as stairlifts.

EP-A1-1.125.882 discloses an incline lift unit having a carriage which is designed to be carried by a guiderail and to move along the latter. A chair is rotatably connected to the carriage. The chair is maintained in an upright position relative to the vertical by a control unit which is not described in any more detail.

The carriage comprises two gear mechanisms which are provided with an electric motor for moving the incline lift unit along. The gear mechanisms are connected to the carriage in the manner of a ball-and-socket joint. The gear mechanisms are each provided with a gearwheel, which engages with a gear rack of the guiderail.

The control unit drives an actuator motor which can rotate the chair relative to the carriage by means of a gearwheel.

The stairlift described above is marketed by the Applicant and comprises an electronic control unit which is supplied with a signal from an inclination sensor which is fitted to the chair.

This known incline lift unit has the drawback that a control arrangement using an inclination sensor is relatively slow, as a result of which the speed of the incline lift unit remains limited.

It is an object of the invention to provide an incline lift unit which at least partly eliminates the abovementioned drawback or in any case to provide an alternative.

This object is achieved by the invention by means of an incline lift unit according to claim 1.

An incline lift unit is designed for conveying a load along a guide with a varying angle of inclination. The incline lift unit comprises a conveying unit which is designed to be carried by the guide and to move along the guide. The incline lift unit furthermore comprises a load carrier, such as a chair or wheelchair platform, which is rotatably connected to the conveying unit. The incline lift unit furthermore comprises rotation means for rotating the load carrier relative to the conveying unit, and a control unit for driving the rotation means in such a manner that the load carrier assumes a desired orientation relative to the vertical. The conveying unit comprises a conveying frame and at least two gear mechanisms. The gear mechanisms are each rotatably connected to the conveying frame and each comprise at least one gearwheel. The gearwheel is intended for engagement with a gear rack of the guide. The incline lift unit furthermore comprises detection means for detecting a difference in rotation of the gearwheels. The control unit is designed to drive the rotation means based on the observation of the detection means.

At an upward bend, the guide has a greater length along its underside, that is to say along the outer bend, than on its upper side. At a downward bend, this is reversed. With the known incline lift, the gear rack extends along the underside of the guide, but within the scope of the invention could also extend along the upper side. Starting from a guide having the gear rack on the underside, the distance between the gearwheels of the two gear mechanisms will increase when an upward bend is passed through. Conversely, the respective distance will decrease in the case of a downward bend. This change in distance translates into a temporary difference in the number of rotations of the gearwheels. By detecting this difference, it is possible to detect when a lift enters or exits a bend, respectively. Based on this detection, the control unit causes the rotation means to rotate the load carrier in an opposite direction. In this manner, the invention provides an incline lift unit which reacts immediately when the inclination of the load carrier changes and thus makes a faster control arrangement and a higher speed of the lift possible.

The invention furthermore relates to an incline lift comprising an incline lift unit and a guide.

Advantageous embodiments are defined in the subclaims.

In particular, the guide of the incline lift is a guiderail comprising a gear rack. Such a gear rack ensures a reliable coupling between the rail and the gearwheels.

More particularly, the gear rack viewed in vertical cross section, extends substantially perpendicularly below or perpendicularly above the centre axis of the guiderail. Due to such an orientation of the gear rack, a relatively simple control unit is possible. The gear rack is thus a direct measure of the upward or downward curve of the guiderail.

The invention will be explained in more detail on the basis of a description of the attached drawings, in which:

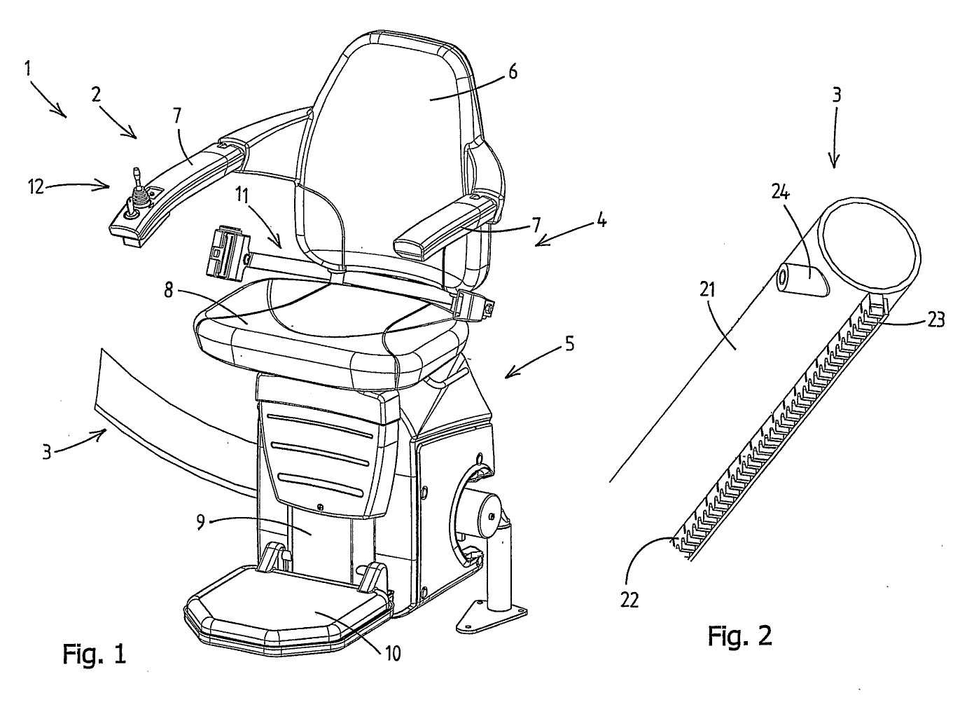

FIG. 1 shows a stairlift according to the invention;

FIG. 2 shows a guiderail for the stairlift according to FIG. 1;

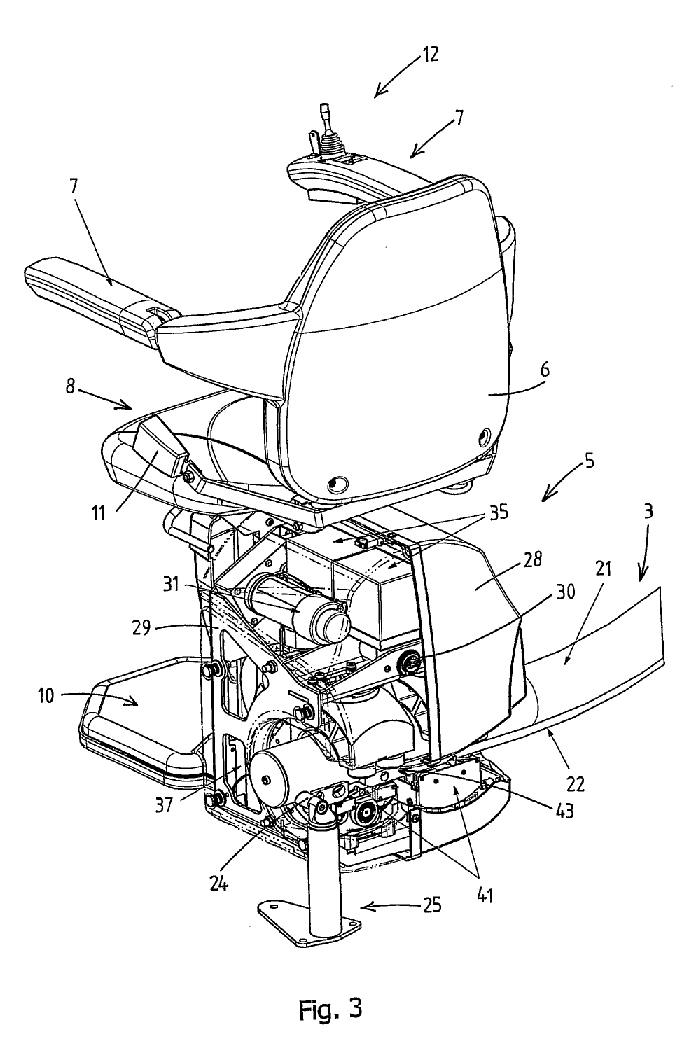

FIG. 3 shows a partially cut-away rear view of the stairlift of FIG. 1;

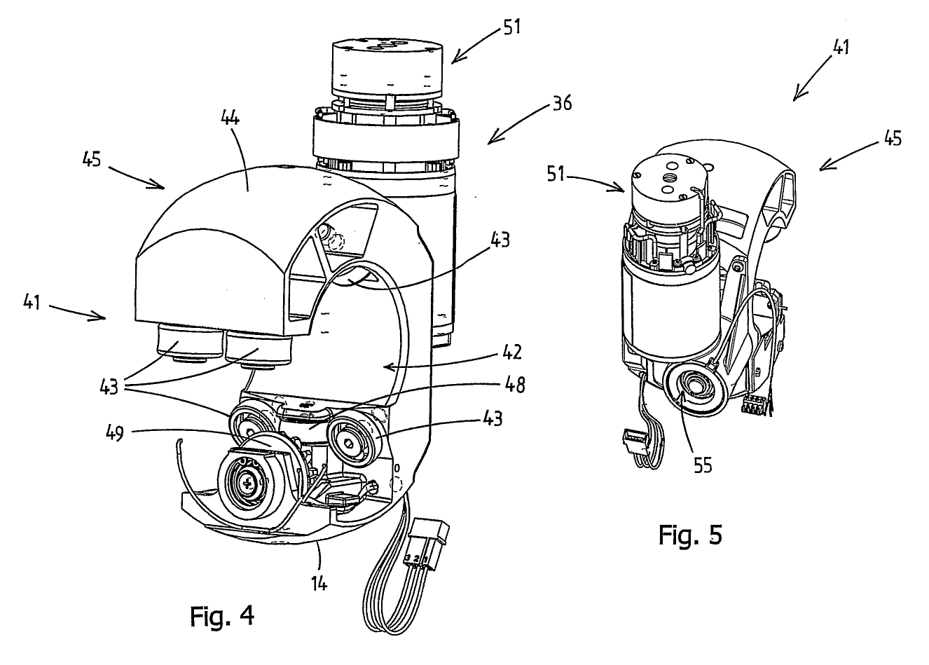

FIG. 4 shows a gear mechanism of the stairlift of FIG. 1 in detail;

FIG. 5 shows a perspective rear view of the gear mechanism of FIG. 4; and

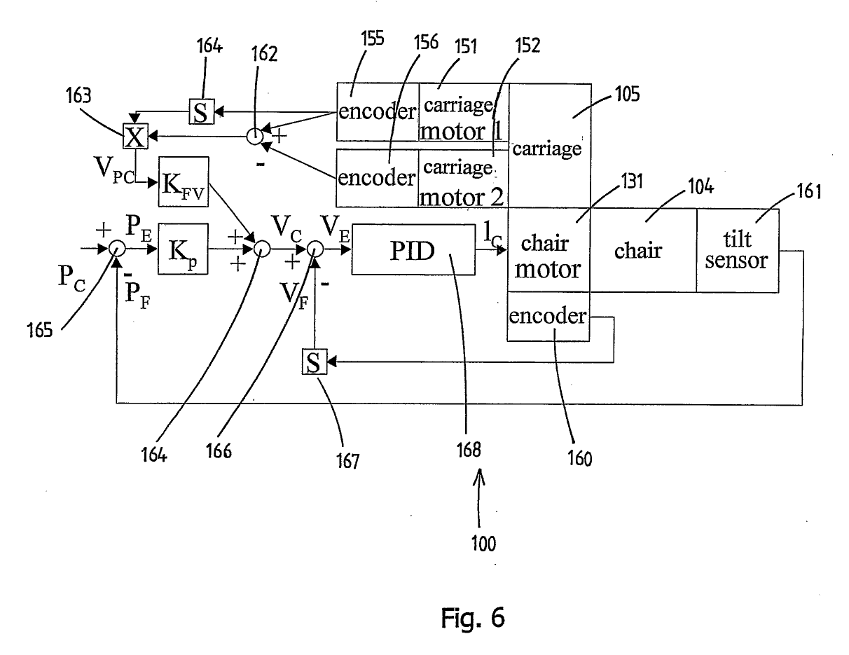

FIG. 6 shows a control scheme for the stairlift according to the invention.

An incline lift, in this case a stairlift, is denoted overall by reference numeral 1 in FIG. 1. The stairlift 1 comprises a stairlift unit 2 according to the invention and a guide in the form of a guiderail 3, which is only partly shown. The guiderail 3 extends, for example, along a staircase and can have various angles of inclination in this case.

The stairlift unit 2 comprises a load unit, or chair 4, and a conveying unit 5, also referred to as carriage or motor unit. The carriage 5 is movably connected to the guiderail 3 and is able to move along the latter (see figures below).

The chair 4 comprises a backrest 6 to which folding armrests 7 are fitted. The chair 4 furthermore comprises a seat 8, on the underside of which a chair plate 9 extends downwards. At the bottom of the chair plate 9, a folding footrest 10 is provided. The chair 4 furthermore comprises a safety belt 11 and control elements 12 which are provided on one of the armrests.

FIG. 2 shows a part of the guiderail 3 in detail. The guiderail 3 comprises a tube 21, in this case a cylindrical tube, a gear rack 22, a supporting strip 23 and attachment points 24. The attachment points 24 are intended to be connected to supports 25 (FIG. 3) which are subsequently connected to a fixed object, for example the steps of a staircase.

The carriage 5 comprises a housing 28 and a frame 29. In FIG. 3, the housing 28 is partly cut away in order to show the interior of the carriage 5.

A rotatable connection 30, partly visible in FIG. 3, connects the chair plate 9, and thus the chair 4, to the carriage 5. Rotation means, in the form of an actuator motor 31, in this case an electric actuator motor, are provided in the carriage 5. The actuator motor 31 is connected to the chair 4 in such a manner that it can be driven in order to rotate the chair 4 relative to the carriage 5.

The carriage 5 furthermore comprises two batteries 35 for the actuator motor 31 and the drive 36 (FIG. 4), which is to be described below, of the carriage 5. The carriage 5 is furthermore provided with a control unit 37, in this case an electronic control unit. The control unit 37 is electrically connected to the actuator motor 31, the drive 36 of carriage 5, the batteries 35 and the sensors to be described below.

The carriage 5 comprises two gear mechanisms 41, which are shown in more detail in FIGS. 4 and 5. Each of the gear mechanisms 41 is connected to the frame 29 so as to form a ball-and-socket joint and each is at least partly spherical.

Each of the spherical gear mechanisms 41 has a passage 42 through which the guiderail 3 extends when the carriage 5 has been installed. Supporting wheels 43 are arranged around the passage 42, which supporting wheels 42, in the mounted state, bear against the tube 21 of the guiderail 3. The guiderail 3 can thus carry the carriage 5.

In the embodiment illustrated here, the gear mechanisms 41 comprise metal bodies 45, at least part of the outer surface of which is convex 44. This convex part 44 is accommodated in the frame 29 of the carriage 5 in a manner similar to that of a ball-and-socket joint, as is illustrated in FIG. 3. Thus, the gear mechanisms 41 are able to rotate about their imaginary centre (not denoted by a reference numeral). The gear mechanisms 41 can independently of one another assume a position corresponding to the course of the guide 3.

The body 45 also accommodates the drive 36, which comprises a gearwheel 49, a transmission (not visible in the figures) and an electric motor 51. The gearwheel 49 engages with the gear rack 22 of the guiderails 3. By being driven by the electric motor 51, the gearwheel 49 is moved along the gear rack 22, thus moving the carriage 5 up and down along the guiderail 3 and thereby the entire stairlift 1.

The sensors connected to the control unit 37 comprise detection means for detecting a difference in rotation of the gearwheels, which are in this case in the shape of two rotational pulse generators or encoders 55, as well as an inclination meter (not shown), also known as tilt or level sensor. This inclination meter is provided on the chair 4.

Each of the rotational pulse generators 55 is connected to the gearwheel 49 of the respective gear mechanism 41 such that it can be driven. The rotational pulse generator 55 emits electrical pulses which are a measure of the rotation of the gearwheel 49. An advantage of such a pulse generator is that in many cases one of these is already present for driving the respective carriage motor. Using this pulse generator is thus an advantageous solution.

The imaginary centres of the gear mechanisms 41 are not located at the gear rack 22. Consequently, as a result of an upward bend in the guiderail 3, a rotation of the gear mechanisms 41 with respect to one another translates into a greater distance between the gearwheels 49. The respective increase in distance can be detected by the encoders 55, as the gearwheel 49 of the front gear mechanism 41 to this end temporarily executes a larger number of rotations than the rear gear mechanism 41. Consequently, a change in the inclination of the guide 3, more particularly of the gear rack 22, is immediately known to the control unit 37, without this information having to be stored in a memory beforehand.

By using sufficiently accurate rotational pulse generators, it is not only known whether the carriage 5 enters an upward or downward bend, but it is also possible to deduce the respective radius of the bend, so that the speed of the actuator motor 31 can be adjusted accordingly.

The signal relating to the difference in rotation of the gearwheels is more stable, better and more quickly available than that of the inclination sensor on the chair 4, since this inclination sensor is relatively slow and detection is affected by the actuator motor 31. The inclination sensor is mainly incorporated as an additional safety measure and in order to provide a signal relating to the actual orientation of the chair, in order to compensate for any deviations in the control signal.

FIG. 6 shows a control scheme 100 for an incline lift unit according to the invention, which can, for example, be implemented in the control unit 37 of the stairlift unit 2 described above. In the control scheme 100, the following elements of an incline lift unit are illustrated diagrammatically: a chair 104, a carriage 105, a chair motor 131, carriage motors 151 and 152 and encoders for the carriage motors 155 and 156. The sensors of this diagrammatic incline lift unit furthermore comprise an encoder or rotational pulse generator 160 for chair motor 131 and an inclination meter or tilt sensor 161.

In 162, the signals of the encoders 155 and 156 are compared with one another. Any differences are supplied to a multiplier 163. A second input of a multiplier 163 is formed by a signal which is representative of the speed of the carriage 105 and which is derived from the encoder signal 155 of the carriage 105 via a differentiation 164.

The multiplier 163 supplies a signal V_{PC} which is representative of the speed of rotation of the carriage 105 about a shaft which is substantially at right angles to the horizontal component of the speed of the carriage 105. In principle, this first signal is sufficient to keep the chair 104 straight. After all, the chair motor 131 has to rotate at a speed which is inversely proportional to the rotational speed of the carriage 105.

Via a correction factor K_{FV}, the first signal is added to a second control signal in 164. This second control signal originates from the tilt sensor 161 and is compared with a desired signal P_{C} in 165. This desired signal corresponds to a position of the tilt sensor which is achieved at a desired orientation of the load carrier relative to the vertical. In 164, the resulting error signal P_{E} is added to the above-described signal of the encoders 155 and 156 using a factor K_{P}. The resulting signal is a measure of the desired speed of rotation of the chair motor 131 (V_{C}). In 166, this is compared with the actual speed V_{F} of the chair motor 131, which originates from the encoder 160 via a differentiation 167. Via a conventional proportional, integral, differential controller (PID controller) 168, a control signal l_{c} is generated for the chair motor 131.

Various variants are possible without departing from the scope of the invention. Thus, each gear mechanism may be provided with a drive motor. However, it is also possible for only one of the gearwheels of one of the gear mechanisms to be driven. In the latter case, the second gear mechanism is provided with a gearwheel which engages with the gear rack in order to be able to detect the rotations of this gearwheel.

The pulse generators can be coupled directly to the gearwheels, as illustrated. However, the pulse generators can also be coupled to the gearwheel, which engages with the gear rack, by means of a gearwheel transmission. Thus, the pulse generator could be provided on a shaft of the drive motors.

Alternative detection means comprise a differential, which is provided between the two gearwheels of the two gear mechanisms in such a manner that it can be driven. This differential may be provided with a pulse generator or other sensor. Via the differential, this sensor detects whether both gearwheels are moving at the same speed or whether one of the two gearwheels is moving at a higher speed than the other one. This signal can be supplied directly to a control arrangement without a comparison of two encoder signals being required, as described with reference to FIG. 6.

Alternatively, the detection means and control unit can also be designed as mechanical means. In this case, the detection means again comprise, for example, a differential. A driven gearwheel of the differential directly drives the chair via a gearwheel transmission in order to adjust the chair relative to the carriage. The relevant gearwheel transmission is in this case to be considered as the rotation means and the ratios between the relevant gearwheels as the control unit.

An incline lift unit according to the invention may also be a means of transport other than a stairlift. Thus, an incline lift unit according to the invention may also extend along a different guide, such as a combination of rails and a gear rack, as is customary with a so-called rack railway.

It is also possible to provide a wheelchair platform rather than a chair, which wheelchair platform is maintained in a horizontal position in the manner described in the invention.

The rotatable connection between the load carrier and the carriage may be effected by means of a shaft on which, for example, an electric actuator motor engages, as described above. Alternatively, the rotatable connection and the rotation means may be integrated, for example in the shape of two power cylinders, such as a hydraulic or pneumatic cylinder. The two cylinders are arranged at a distance from one another and are connected to the carriage by a first end and to the load carrier by a second end. The fact that the two power cylinders move in opposite directions brings about a rotational movement of the load carrier relative to the carriage.

With the above-described control arrangement, the tilt sensor provides additional accuracy and/or safety. In principle, the control according to the invention can also operate without a tilt sensor.

In this manner, the invention provides an incline lift unit provided with detection means for detecting a difference in rotation of the gearwheels which engage with the gear rack. This produces a signal which can be used for adjusting a load carrier. It is advantageous that the control arrangement is able to react more quickly to bends in a rail, than is the case when (only) one inclination sensor is used. In this case, no data on the guiderail have to be stored as upward and downward bends can be read out directly via the detection means. As most of the required hardware is already present in an existing stairlift, this is also an economical solution.

1. An incline lift unit, for conveying a load along a guide with a varying angle of inclination, comprising:
a conveying unit which is designed to be carried by the guide and to move along the guide,
a load carrier, such as a chair or wheelchair platform, which is rotatably connected to the conveying unit,
rotation means for rotating the load carrier relative to the conveying unit, and
a control unit for driving the rotation means in such a manner that the load carrier assumes a desired orientation relative to the vertical, wherein
the conveying unit comprises a conveying frame and at least two gear mechanisms, which gear mechanisms are each rotatably connected to the conveying frame and each comprise at least one gearwheel which is intended for engagement with a gear rack of the guide, and detection means for detecting a difference in rotation of the gearwheels, wherein the control unit is designed to drive the rotation means based on the observation of the detection means.

2. The incline lift unit according to claim 1, wherein the detection means comprise electronic detection means.

3. The incline lift unit according to claim 2, wherein the electronic detection means comprise at least one rotational pulse generator.

4. The incline lift unit according to claim 3, wherein the gearwheels of the at least two gear mechanisms are each rotatably connected to a separate rotational pulse generator.

5. The incline lift unit according to claim 1, wherein the control unit is an electronic control unit.

6. The incline lift unit according to claim 1, further comprising an inclination meter which detects the angle of the load carrier relative to the vertical, wherein the control unit is designed to drive the rotation means partly based on the observation of the inclination meter.

7. An incline lift, for conveying a load along a guide with a varying angle of inclination, comprising:
a guide;
a conveying unit which is designed to be carried by the guide and to move along the guide,
a load carrier, such as a chair or wheelchair platform, which is rotatably connected to the conveying unit,
rotation means for rotating the load carrier relative to the conveying unit, and
a control unit for driving the rotation means in such a manner that the load carrier assumes a desired orientation relative to the vertical, wherein
the conveying unit comprises a conveying frame and at least two gear mechanisms, which gear mechanisms are each rotatably connected to the conveying frame and each comprise at least one gearwheel which is intended for engagement with a gear rack of the guide, and detection means for detecting a difference in rotation of the gearwheels, wherein the control unit is designed to drive the rotation means based on the observation of the detection means.

8. The incline lift according to claim 7, wherein the guide is a guiderail and comprises a gear rack.

9. The incline lift according to claim 8, wherein the gear rack, viewed in vertical cross section, extends substantially perpendicularly below or perpendicularly above the centre axis of the guiderail.
